(19) United States
(12) Patent Application Publication
(10) Pub. No.: US 2026/0295917 A1
(43) Pub. Date: Oct. 1, 2026

(54) ON- AND OFFSHORE LONG-CHAIN POLYAMIDE TUBE WITH INCREASED BARRIER EFFECT

(71) Applicant: Evonik Operations GmbH, Essen (DE)

(72) Inventors: Carsten Schütt, Recklinghausen (DE); Hermann Van Laak, Huenxe (DE); Karl Kuhmann, Duelmen (DE); Alexander Brack, Essen (DE)

(73) Assignee: Evonik Operations GmbH, Essen (DE)

(21) Appl. No.: 19/476,750

(22) PCT Filed: Apr. 17, 2024
(86) PCT No.: PCT/EP2024/060377

§ 371 Date: Oct. 20, 2025

(30) Foreign Application Priority Data
Apr. 24, 2023 (EP) 23169462.1

(51) Int. Cl. B29C 48/09; B29C 48/00; B29C 48/18; B29K 23/00; B29K 77/00; B29K 307/04; B29L 23/00

(52) U.S. Cl. CPC B29C 48/09; B29C 48/022; B29C 48/18; B29K 2023/086; B29K 2077/00; B29K 2307/04; B29L 2023/22

(57) ABSTRACT

Multilayered hollow bodies, in particular multilayered polyamide pipes, have an improved barrier effect against H₂ permeation.

The invention relates to a multilayered hollow body which through selection of the employed moulding materials of its individual layers exhibits a reduced permeation of for example hydrogen (H₂), H₂S, CO₂ and CH₄, wherein the reduction in permeation of hydrogen (H₂) is preferred. The multilayer hollow body is primarily a hollow profile, for example a pipe, or a vessel for conduction or storage of liquid or gaseous media.

Multilayered hollow bodies are employed in particular as offshore pipe or onshore pipe or a subsection of a corresponding offshore pipeline or onshore pipeline. An offshore pipe is typically laid on the bottom of a body of water or therebelow in a trench while an onshore pipe is laid on land. Offshore pipes and onshore pipes may be combined with one another to form pipelines in order that liquid or gaseous media may be transported over large distances both underwater and on land. Known offshore pipes and onshore pipes are typically made of steel.

The increasing politically driven focus of the primary energy sector on renewable and climate neutral energy carriers or the conducting and storage of climate-damaging gases brings conventional steel pipe infrastructure strongly to the fore for safety engineering considerations. Particularly hydrogen embrittlement (HE) of austenitic steels and welded joints is a problem that must be solved with increased technical effort, especially when the lower energy density of hydrogen (H₂) compared to natural gas/methane must be compensated by higher pressures. This requires systems which meet the posed H₂ permeation demands not met by conventional pipe materials.

Hydrogen embrittlement is to be understood as meaning the change in the strength of metals, more precisely their brittleness, caused by the penetration and the intercalation of hydrogen (H₂) into their metal lattice. This corrosion is similar to material fatigue. As a consequence this leads to hydrogen-induced fracturing which especially limits the use of susceptible materials for hydrogen storage and/or hydrogen conduction.

The prior art discloses multilayered hollow bodies, in particular pipes, that are provided with a metallic barrier layer, for example of aluminium, for protection from hydrogen which entails elevated manufacturing and material costs. Such pipes are known for example as polymer composite pipes and “reinforced thermoplastic pipes” (RTPs).

These known multilayered hollow bodies moreover suffer from the risk of “cover blowoff” at very high pressures since over a long periods via the so-called “tortoise effect” aluminium winding plies allow permeation of H₂ under the unwelded polymeric sheathing, thus leading to the establishment of a partial pressure of H₂ over time. This can lead to loss of the sheathing of the hollow body.

RTPs are used only in higher pressure ranges and presently only onshore.

“Thermoplastic composite pipes” (TCPs) are also known. These are reinforced composite multilayered pipes which do not suffer from any risk of “cover blowoff”. While H₂ permeation is reduced it is not as low as for unbonded onshore RTPs having an aluminium layer.

The hollow bodies known from the prior art are thus not satisfactory in every respect.

It is therefore an object of the present invention to provide hollow bodies that have advantages over the known hollow bodies.

This object is achieved by the subject-matter of the claims.

It has surprisingly been found that in the field of “onshore unreinforced up to 18 bar” manufacturing and cost advantages were able to be achieved relative to RTPs by multilayered hollow bodies according to the invention produced by coextrusion processes. In addition, H₂ embrittlement may be avoided relative to steel in the onshore field.

It has surprisingly been found that in the offshore field it is possible to achieve an even better barrier effect for TCPs qualified on the basis of PA 12.

It has further surprisingly been found that an ethylene vinyl alcohol copolymer (EVOH) barrier layer in a multilayered pipe concept with adhesion promoter based on polyamide (PA), in particular based on PA 6 and PA 6.12 (i.e. PA6/PA612 mixture), makes it possible in the coextrusion process to optimize high molecular weight, chain-extended large pipe extrusions/polyamide moulding materials based on polyamide, in particular based on PA 12, in respect of H₂ permeation.

It has further surprisingly been found that a pipe composite also works mechanically in the case of markedly off-centre arrangement of the EVOH barrier layer, for example as the innermost layer in direct interaction with H₂. This layer is normally arranged very centrally in small pipes.

It has further surprisingly been found that the adhesion mechanism of the adhesion promoter composition based on PA6 and PA612 surprisingly works with chain-extended PA compounds/polyamides. It is particularly noteworthy that depending on the composition no compatibilization is necessary.

The use of the chain-extended PA 12 compounds in combination with an EVOH barrier layer allows transport of inter alia H₂ streams in advantageous fashion, in particular in respect of reduced H₂ permeation.

In particular the invention for the first time allows large diameter on- and offshore polyamide pipes for many applications in unreinforced systems for H₂-ready applications (MOP 16 or 18 bar) onshore through to 100% green H₂ reinforced pipes (thermoplastic composite pipes (TCP) and reinforced thermoplastic pipes (RTP)) for offshore applications of higher pressure classes. MOP is the abbreviation for “maximum operating pressure”. This is the maximum allowable operating pressure at which a system may be permanently operated under normal operating conditions.

Sensitivity to HE is not inherent in polyamides. HE is therefore eliminated from the start, likewise “conventional” corrosion. The requirement against H₂ permeation into the environment is demonstrably met via the functionality of the EVOH barrier layer. The relevant context is “secondary greenhouse gas emissions”. H₂ is indirectly climate-damaging since it keeps other direct greenhouse gases such as CH₄ and CO₂ stable for longer and thus in greater concentration in the atmosphere. Political efforts towards “zero-permeation solutions” are expected.

Even the geometric embodiment with a very thin EVOH barrier layer (~0.3 mm) at a total diameter of 50 mm and larger and wall thicknesses of 3 mm and larger surprisingly ensure mechanical system performance similar to a monopipe at drastically reduced H₂ permeation. EVOH barriers layers smaller than 0.3 mm, for example a layer thickness of 0.1 mm, also reduce H₂ permeation considerably relative to the monopipe. Thicker layers too (up to 0.8 mm) were examined. No differences in terms of mechanical performance were able to be determined.

A further potential use in the transport of supercritical CO₂ is envisaged, this representing a considerable problem for steel. Further applications comprise the conveying of multiphase fluids with high demands on the barrier effect (H₂S, CO₂, CH₄, etc).

The multilayered hollow body is moreover readily processable and is windable, in particular windable in industrially relevant diameters.

According to the invention, pipe constructions can therefore be configured more flexibly and the arrangements and geometries of the EVOH barrier layer optimized according to the pipe construction/the other layers.

The multilayered hollow body according to the invention further makes it possible to take into account the particular requirements of the moulding materials in terms of layer thickness-diameter ratio on the part of the coextrusion process employed for their production: Melt stiffness on the one hand; residence times; adhesion; small-volume EVOH barrier layer plus small-volume adhesion promoter layer plus large-volume support layer PA (12, 6.12, etc.).

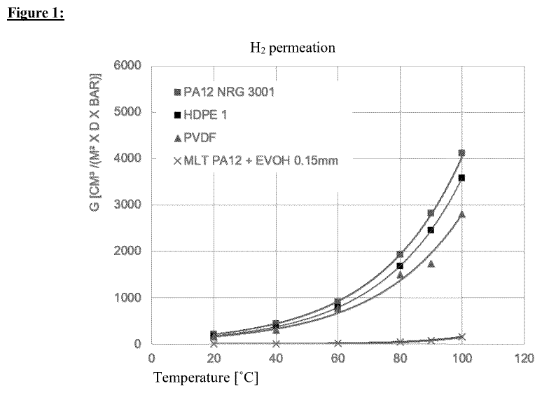

FIG. 1 illustrates the H₂ permeability of selected polymers and of the PA 12-EVOH-MLT system.

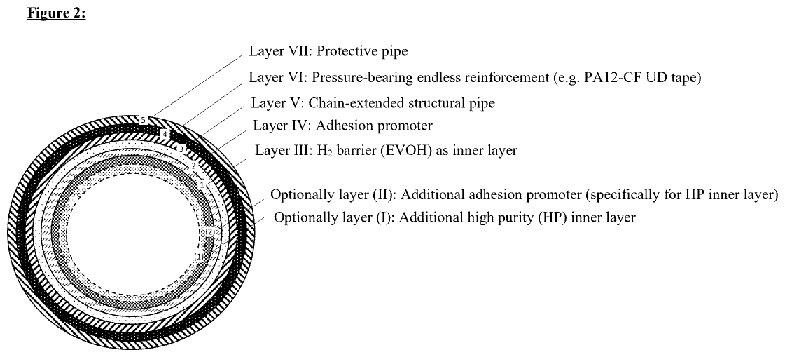

FIG. 2 illustrates the PA 12-EVOH-MLT-TCP concept for 100% H₂-high pressure for offshore applications.

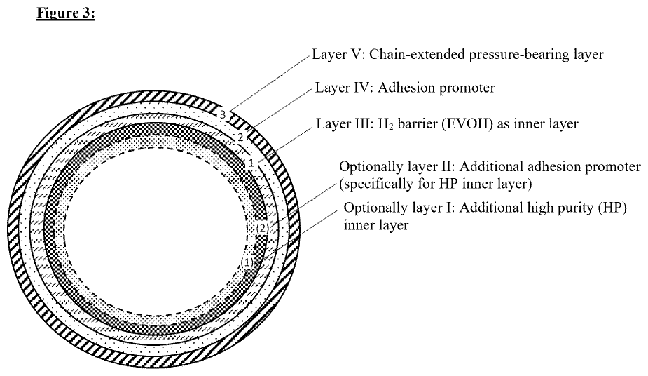

FIG. 3 illustrates the PA 12-EVOH gas pipe concept for 16 and 18 bar MOP for onshore applications.

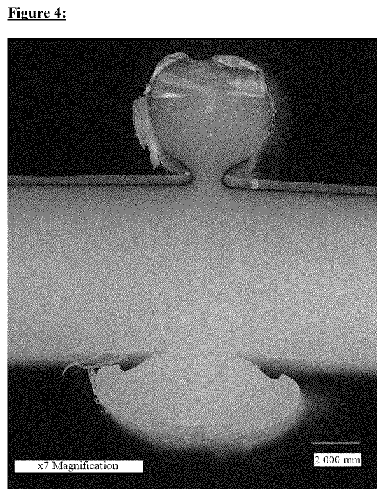

FIG. 4 shows a welded test specimen.

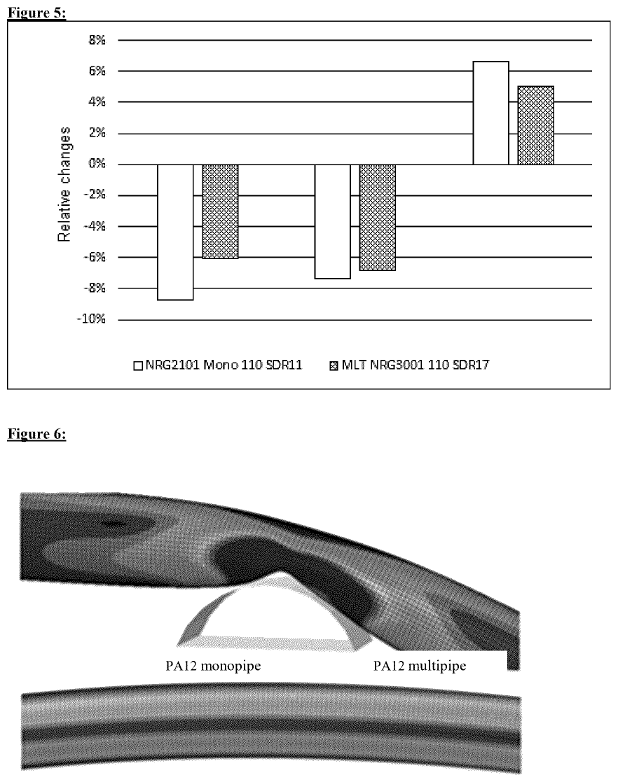

FIG. 5 illustrates tensile strength properties of welded samples compared to unwelded samples for mono- and multilayered pipes.

FIG. 6 illustrates examinations of the washability of an MLT pipe having an inner EVOH barrier layer.

In a first aspect the invention relates to a multilayered hollow body, in particular for the transport, the transmission, the distribution and/or the storage of gases and/or liquids which from the inside outwards comprises or consists of the following layers:
optionally a layer I which comprises or consists of a moulding material containing polyethylene (PE), polyvinylidene fluoride (PVDF), polytetrafluoroethylene (PTFE), perfluoroalkoxy (PFA), poly(tetrafluoroethylene-perfluoromethylvinyl ether) (MFA), fluoroethylenepropylene (FEP) and/or ethylene-chlorotrifluorethylene (ECTFE); and preferably comprises or consists of PE-HP, PVDF-HP, PFA-HP, MFA-HP and/or FEP-HP (HP=high purity);
optionally a layer II which is an adhesion promoter layer and comprises or consists of a moulding material containing PA 6, PA 6.12, copolymers thereof and/or mixtures thereof;
a barrier layer (layer III) which comprises or consists of a moulding material containing ethylene-vinyl alcohol copolymer (EVOH);
an adhesion promoter layer (layer IV) which comprises or consists of a moulding material containing PA 6, PA 6.12, copolymers thereof and/or mixtures thereof;
a layer V which comprises a moulding material containing at least one chain-extended polyamide; and preferably comprises or consists of chain-extended PA 12, chain-extended PA 6.12, chain-extended bio-PA, copolymers thereof and/or mixtures thereof, wherein the chain-extended polyamides are obtainable using a chain-extending additive which has at least 2 carbonate units per molecule;
optionally a layer VI which comprises or consists of a moulding material containing carbon fibre-reinforced PA 12; and
optionally a layer VII which is a protective sheathing.

The multilayered hollow body is preferably configured for the transport, the transmission, the distribution and/or the storage of gases and/or liquids.

Layer I or layer II is in direct contact with the conveyed or stored medium, preferably H₂.

The barrier layer (layer III) acts as a barrier especially against H₂-permeation. In the absence of layers I and II, layer III is in direct contact with the conveyed or stored medium, preferably H₂.

High purity inner layers have the feature that in media contact the media can at most leach out marginal constituents (“extractables”) from the inner layer. Furthermore these extremely low leach out levels are negligible for the high purity of the medium to be transported in respect of its intended purpose.

A person skilled in the art is capable of determining a level of leach out that is still acceptable on a case-by-case basis.

For example a person skilled in the art is capable in connection with a fuel cell of determining a still-acceptable level of impurities in the hydrogen (H₂) which does not reduce the functionality of the fuel cell.

The multilayered hollow body preferably has a gas permeability (G), preferably permeability of H₂, in a temperature interval of 20 to 100 degrees Celsius of at most 200 or at most 300 or at most 400 or at most 500 or at most 1000 cm³/m²*d*bar, preferably in each case determined according to DIN 53380, part 1.

The barrier layer (layer III) preferably has a gas permeability (G), preferably permeability of H₂, in a temperature interval of 20 to 100 degrees Celsius of at most 200 or at most 300 or at most 400 or at most 500 or at most 1000 cm³/m²*d*bar, preferably in each case determined according to DIN 53380, part 1.

If the hollow body according to the invention has a layer VI which comprises or consists of a moulding material containing carbon fibre-reinforced PA 12 this is preferably unidirectionally (UD) fibre-reinforced endless tapes which preferably have a proportion of carbon fibres of 40% to 50% by volume and a proportion of low-viscosity PA 12 of 40-60% by volume. It is particularly preferable when these unidirectionally fibre-reinforced endless tapes comprise a proportion of carbon fibres of about 45% by volume and a proportion of low-viscosity PA 12 of about 55% by volume. The carbon fibres preferably have a diameter of 4-15μ, particularly preferably of 7-12μ. The PA 12 preferably has a melt viscosity in the range from 10 to 100 Pas, measured with an Anton Paar MCR 502 rheometer with a plate-plate system (plate distance d=25 mm) with an angular frequency of 1000/minute at a temperature of 280° C.

The (wall) thickness of layer III is preferably
at least 0.2 mm or at least 0.3 mm or at least 0.4 mm or at least 0.5 mm; and/or
at most 0.6 mm or at most 0.7 mm or at most 0.8 mm or at most 0.9 mm or at most 1.0 mm.

The (wall) thickness of layer IV is preferably
at least 0.1 mm or at least 0.12 mm or at least 0.15 mm or at least 0.17 mm; and/or
at most 0.2 mm or at most 0.22 mm or at most 0.24 mm or at most 0.30 mm or at most 0.5 mm.

The (wall) thickness of layer V is preferably
at least 5.0 mm or at least 6.0 mm or at least 7.0 mm or at least 8.0 mm or at least 9.0 mm; and/or
at most 10.0 mm or at most 11.0 mm or at most 12.0 mm or at most 13.0 mm or at most 15.0 mm.

Methods for determining suitable (wall) thicknesses are known to those skilled in the art, for example the calculation using “Barlow's formula”.

The (wall) thicknesses are preferably determined according to the standard DIN EN 13480-3:2017-12.

The internal diameter (i.e. diameter without taking into account the layers) of the multilayered hollow body according to the invention, in particular of the onshore and/or offshore pipe, is preferably at least 30 mm or at least 50 mm and/or at most 160 mm or at most 300 mm or at most 350 mm.

The multilayered hollow body according to the invention may comprise the same or different polyamides (PA) in different layers. Such polyamides and the abbreviations used to describe them are known to those skilled in the art.

A polyamide especially suitable in the context of the invention is based on lactams and aminocarboxylic acids (perlon type) or diamines and dicarboxylic acids (nylon type). It may moreover contain branching units derived for example from tricarboxylic acids, triamines or polyethyleneimine. Suitable types include, in each case as a homopolymer or as a copolymer, for example PA 6, PA 4.6, PA 6.6, PA 6.10, PA 6.6/6, PA 6/6T, PA 6.6/6T and in particular PA 6.12, PA 10.10, PA 10.12, PA 12.12, PA 6.13, PA 10.14, PA 11, PA 12 or a transparent polyamide.

Suitable transparent polyamides include for example:
the polyamide of terephthalic acid and the isomer mixture of 2,2,4- and 2,4,4-trimethylhexamethylenediamine,
the polyamide of isophthalic acid and 1,6-hexamethylenediamine,
the copolyamide of a mixture of terephthalic acid/isophthalic acid and 1,6-hexamethylenediamine,
the copolyamide of isophthalic acid, 3,3′-dimethyl-4,4′-diaminodicyclohexylmethane and laurolactam or caprolactam,
the (co) polyamide of 1,12-dodecanedioic acid, 3,3′-dimethyl-4,4′-diaminodicyclohexylmethane and optionally laurolactam or caprolactam,
the copolyamide of isophthalic acid, 4,4′-diaminodicyclohexylmethane and laurolactam or caprolactam,
the polyamide of 1,12-dodecandioic acid and 4,4′-diaminodicyclohexylmethane and/or
the copolyamide of a terephthalic acid/isophthalic acid mixture, 3,3′-dimethyl-4,4′-diaminodicyclohexylmethane and laurolactam.

Also suitable are polyetheramides based on lactams, aminocarboxylic acids, diamines, dicarboxylic acids and polyether diamines and/or polyether diols.

PA 6 is preferably produced by ring-opening polymerization of caprolactam.

PA 11 is preferably produced by polycondensation of @-aminoundecanoic acid, while PA 12 is obtained by ring-opening polymerization of laurolactam. Both polymers are commercially available in a multitude of types.

PA 6.10 is preferably produced in known fashion by polycondensation of an equivalent mixture of hexamethylenediamine and 1,10-decanedioic acid, while PA 6.12 is preferably produced in known fashion by polycondensation of an equivalent mixture of hexamethylenediamine and 1,12-dodecanedioic acid and PA 10.10 is preferably produced in similarly known fashion by polycondensation of an equivalent mixture of 1,10-decanediamine and 1,10-decanedioic acid.

PA 10.12 is preferably produced by polycondensation of an equivalent mixture of 1,10-decanediamine and 1,12-dodecanedioic acid, while PA 12.12 is obtained in the same way from 1,12-dodecanediamine and 1,12-dodecanedioic acid.

PA 6.6 is preferably produced by polycondensation of hexamethylenediamine and adipic acid. Similarly to PA 6 it is commercially available in a multitude of types.

PA 6/6.6 is a copolycondensate proceeding from the monomers caprolactam, hexamethylenediamine and adipic acid.

It is preferable to employ mixtures of different polyamides, for example PA 12/PA 10.12 or PA 12/PA 12.12. Mixtures of this kind feature particularly high low-temperature impact resistance and are described, for example, in EP-A-0 388 583.

Bio-PA is a polyamide based on renewable raw materials. The monomers are preferably obtained wholly or partially from castor oil.

It is preferable when at least one layer contains a polyamine-polyamide copolymer.

The polyamine-polyamide copolymer is preferably produced using the following monomers:
a) 0.5% to 25% by weight, preferably 1% to 20% by weight and particularly preferably 1.5% to 16% by weight, based on the polyamine-polyamide copolymer, of a polyamine having at least 4, preferably at least 8 and particularly preferably at least 11 nitrogen atoms and a number-average molecular weight Mn of at least 146 g/mol, preferably of at least 500 g/mol and particularly preferably of at least 800 g/mol, and
b) polyamide-forming monomers selected from lactams, @-aminocarboxylic acids and/or equimolar combinations of diamine and dicarboxylic acid.

In a preferred embodiment the amino group concentration of the polyamine-polyamide copolymer is in the range from 100 to 2500 mmol/kg.

These and further suitable polyamine-polyamide copolymers and methods for the production thereof are known to those skilled in the art for example from the publication EP-A-3 299 165.

In a preferred embodiment the multilayered hollow body does not contain layer I or does not contain layer I and layer II, and layer III is simultaneously the barrier layer and the inner layer. Layer V comprises a moulding material containing at least one chain-extended polyamide.

Exemplary processes for chain extension are defined below.

In a preferred embodiment the moulding material of layer V is obtainable by condensation of a PA12, PA612 and/or bio-PA moulding material with a compound having at least two carbonate units and the polyamide proportion of the PA 12, PA 6.12 and/or bio-PA moulding material contains at least 5 ppm of phosphorus in the form of an acidic compound as a consequence of manufacture, wherein
a) 0.001% to 10% by weight, based on the polyamide, of a salt of a weak acid is added to the polyamide before compounding or during compounding and
b) a mixture of the finished compound and 0.005% to 10% by weight, based on the polyamide, of the compound having at least two carbonate units is produced.

In a preferred embodiment
the polyamide proportion contains 20 to 500 ppm of phosphorus in the form of an acidic compound; and/or
the polyamide is admixed with 0.001% to 5% by weight, preferably 0.01% to 2.5% by weight, particularly preferably 0.05% to 1% by weight, of a salt of a weak acid and the weak acid preferably has a pKa of 2.5 or higher and/or the salt of the weak acid is preferably an alkali metal salt, an alkaline earth metal salt, the salt of a metal of main group III, the salt of a metal of subgroup II, or an ammonium salt; and/or
the polyamide was produced using a diamine or polyamine as a chain-transfer agent; and/or
the compound having at least two carbonate units is employed as a masterbatch.

Those skilled in the art are familiar with how to achieve defined synthesis of the termini of polyamides. This is done with so-called chain-transfer agents. In the case of nylon-type polyamides this may be a simple stoichiometric excess of one of the two components. Or a so-called external chain-transfer agent is added, wherein this may be performed for both polyamide types (perlon and nylon). In the context of polyamide formation these chain-transfer agents may be diamines or diacids, for example.

The methods of determination for the end groups of polyamides are in principle known to those skilled in the art. Determination of the carboxyl end groups is preferably performed by dissolution of the polymer in benzyl alcohol and alkalimetric titration with alcoholic KOH (0.1 mol/l stock solution) against phenolphthalein. Determination of the amino end groups is preferably carried out in m-cresol by dissolution of the polyamide at elevated temperature. Potentiometric endpoint determination is carried out.

Provided the polyamide was produced using a diamine or polyamine it may be obtained with an excess of amino end groups. The amino end group concentration may preferably be determined by means of potentiometric titration. To this end for the amino end groups for example 0.2 to 1.0 g of polyamide are dissolved in a mixture of 50 ml of m-cresol and 25 ml of isopropanol at 50° C. to 90° C. and after addition of aminocaproic acid titrated with a 0.05 molar perchloric acid solution.

These and further options for producing chain-extended polyamides are known to those skilled in the art from the publication EP 1 690 890 A1.

In a preferred embodiment the moulding material of layer V contains a viscosity modifier (i.e. an additive) which during thermoplastic processing results in a molecular weight increase through chain extension of polyamide molecules. A preferred variant of a viscosity modifier is a polycarbonate in an acid-terminated polyamide. Such a viscosity modifier is commercially available for example under the designation Brüggolen® M 1251 (trademark of Brüggemann GmbH & Co KG, Germany) from Brüggemann Chemical (Deutschland), this being a masterbatch of a low viscosity polycarbonate in an acid-terminated polyamide 6.

Such Bruggolens® are capable of reacting with amine-regulated polyamide, for example amine-regulated PA 12, during an extrusion, so that the polymer chain is extended and the molar mass increases.

In the reaction of an amine-regulated polyamide, for example of amine-regulated PA 12, with a Brüggolen®, for example Brüggolen® M 1251, the proportion of Brüggolen® is preferably less than 2% by weight based on the total weight of the amine-regulated polyamide and the Brüggolen®.

In a preferred embodiment the moulding material of layer V contains or consists of chain-extended PA of the following formulae:

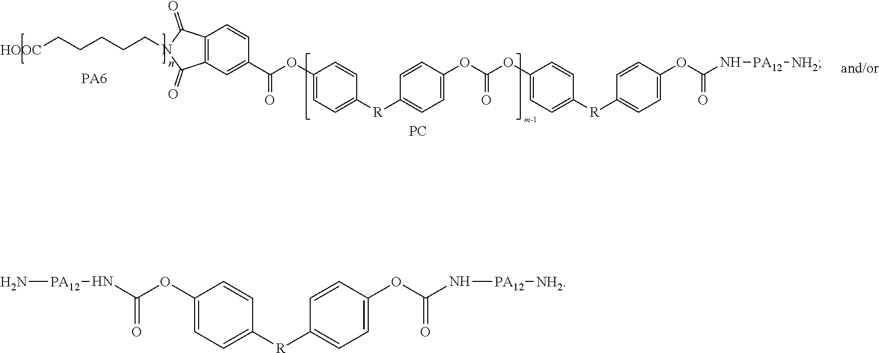

Further processes for chain extension are known to those skilled in the art from the publications WO 2000/066650, EP 2 687 554 A1 and EP 2 610 279 A1.

In a preferred embodiment the polyamides, in particular the polyamides of layer V, are admixed with a chain-extending additive, such as carbonyl-bis-caprolactam (CBC), N—N′-terephthaloyl-bis-caprolactam, bisoxazoline, diisocyanates, capped diisocyanates, carbodiimides, epoxy-functionalized 5 oligomers or polymers or additives based on carbonate units.

The preferred chain-extending additives have at least 2 carbonate units per molecule, preferably 5, more preferably 10, yet preferably 20, particularly preferably 30, more particularly preferably 40 and especially preferably at least 50 carbonate units per molecule.

Particularly preferred chain-extending additives are disclosed in WO 2000/066650, especial preference being given to chain-extending additives such as block copolymers of formula PA·PC, wherein PA is polyamide and PC is polycarbonate.

The polycarbonate has at least 2 carbonate units, preferably 10, more preferably 20, more preferably 30, particularly preferably 40 and in particular at least 50. The polycarbonate preferably comprises 2 to 100, particularly preferably 30 to 80 and especially preferably 40 to 70 carbonate units.

The chain extender is present in a masterbatch of acid-terminated polyamide and is reacted with an amine-terminated polyamide.

The chain-extending additive preferably comprises 25% to 75% by weight, more preferably 35% to 65% by weight and especially preferably 45% to 55% by weight of polycarbonate.

Such processes for chain extending of polyamides are known to those skilled in the art from the publications EP 1 690 890 A1, WO 01/53382 A1 and WO 01/66643 A1.

In a preferred embodiment the following layers are directly consecutive
layers I, II, III, IV and V or
layers I, II, III, IV, V, VI and VII or
layers III, IV and V or
layers III, IV, V, VI and VII;
   and/or
layer III is arranged off-centre.

According to the invention the term “arranged off-centre” is to be understood as meaning that starting from the layer arranged off-centre the number of layers in the inward direction, i.e. towards the medium transported, does not correspond to the number of layers in the outward direction. It is thus also possible according to the invention for two or more layers of a multilayered hollow body to be arranged off-centre.

In a preferred embodiment the moulding material of layer V contains
additional polyamides, copolymers thereof and/or mixtures thereof,
preferably PA 8, PA 9, PA 10, PA 11, PA 12, PA 4.6, PA 6.10, PA 6.12, PA 6.13, PA 6.14, PA 6.16, PA 8.10, PA 8.13, PA 9.10, PA 9.12, PA 10.10, PA 10.12, PA 10.14, PA 10.16, PA 10.18, PA 12.12, PA DACH.6 (diaminocyclohexane), PA DACH.10, PA DACH.12, PA DACH. 10/11, PA PACM.6 (4,4-diaminodicyclohexylmethane), PA PACM.10, PA PACM.12, PA MACM.6 (3,3′-dimethyl-4,4′-diaminocyclohexylmethane), PA MACM.10, PA MACM.12. PA 6.T (T=terephthalic acid), PA 9.T, PA 10.T, PA 12.T, PA 6.I (I=isophthalic acid), PA 9.I, PA 10.I, PA 12.I, PA 6.N (2,6-naphthalenedicarboxylic acid), PA 10.N, PA 12.N, PA MXD.6 (MXD=meta-xylylenediamine), PA MXD.10, PA MXD.12, PA IPD.6 (isophoronediamine), PA IPD.10, PA IPD.12, PA IND.6 (isononyldiamine, 1,6-diamino-2,4,4-trimethylhexane), PA IND.10, PA IND.12, PA ND.6 (nonyldiamine, 1,6-diamino-2,2,4-trimethylhexane), PA ND.10, PA ND.12, copolymers thereof and/or mixtures thereof.

In a preferred embodiment
the moulding material of layer I contains PE-HP, PVDF-HP, PFA-HP, MFA-HP and/or FEP-HP, in each case individually or altogether in an amount of at least 80% by weight, preferably at least 85% by weight and especially preferably at least 90% by weight, in each case based on the total weight of layer I and/or the moulding material of layer I; and/or
the moulding material of layer V contains chain-extended PA 12, chain-extended PA 6.12, chain-extended bio-PA, copolymers thereof and/or mixtures thereof, in each case individually or altogether in an amount of at least 50% by weight, preferably at least 60% by weight, particularly preferably at least 65% by weight and especially preferably at least 70% by weight, in each case based on the total weight of layer V and/or the moulding material of layer V.

In a preferred embodiment there adjoin in the outward direction a further outer layer (layer VIII), optionally yet a further outer layer (layer IX), optionally yet a further outer layer (layer X) and optionally yet further outer layers which each independently of one another comprise a moulding material preferably containing polyamides, copolymers thereof and/or mixtures thereof.

In a preferred embodiment the multilayered hollow body is windable, in particular windable in industrially relevant diameters and is preferably a windable pipe.

In a preferred embodiment the hollow body is three-, four-, five-, six- or seven-layered.

The hollow body according to the invention may in particular be configured in five layers if an additional encapsulation of the blocking layer is necessary. The encapsulation is to be understood as meaning a protection from leach out and other migrations of substances into the surrounding and/or conducted medium.

In a preferred embodiment the multilayered hollow body is
a hollow profile, preferably a pipe or a container; and/or
a component of a fuel-conducting system; and/or
a gas conducting pipe; and/or
an onshore and/or offshore pipe or at least a subsection thereof.

The multilayered hollow body according to the invention is preferably not a brake line, nor a clutch line, nor a coolant line, nor a cable duct, nor a forecourt supply pipe, nor a ventilation duct nor an air intake pipe.

The multilayered hollow body according to the invention is preferably not a constituent of a car.

In a preferred embodiment the multilayered hollow body contains layer I and layer II or does not contain these layers and layer III is the barrier and inner layer, layer IV is a moulding material comprising or containing PA 6 and PA 6.12, layer V is a moulding material comprising or containing chain-extended PA 12, no additional outer layers adjoin in the outward direction and layers I, II, if present, III, IV and V are directly consecutive (see FIG. 3). This multilayered hollow body is an onshore pipe and is characterized in that it may be welded by commonly used methods, in particular by hot-plate welding and/or socket welding.

In a preferred embodiment the multilayered hollow body contains layer I and layer II or does not contain these layers and layer III is the barrier and inner layer, layer IV is a moulding material comprising or containing PA 6 and PA 6.12, layer V is a moulding material comprising or containing chain-extended PA 12, a second outer layer (layer VI) which is a moulding material comprising or containing carbon fibre-reinforced PA 12 adjoins in the outward direction, a third outer layer (layer VII) which is a protective sheathing adjoins in the outward direction and layers I, II, if present, III, IV, V, VI and VII are directly consecutive (see FIG. 2). This multilayered hollow body is an offshore pipe and is characterized in that it may be welded by commonly used methods, in particular by hot-plate welding and/or socket welding.

It is understood by a person skilled in the art that-if the multilayered hollow body according to the invention comprises a layer VI which comprises a moulding material containing carbon fibre-reinforced PA 12 in the form of unidirectionally endless fibre-reinforced tapes—the resulting hollow bodies may be welded by socket welding but not by hot-plate welding.

In a particularly preferred embodiment the multilayered hollow body is a three- or five-layered chain-extended PA multilayered pipe (i.e. a multilayered pipe containing chain-extended polyamide) with a barrier effect against H₂ permeation or at least a portion of this pipe, in each case configured for offshore and/or onshore applications.

In a particularly preferred embodiment the multilayered hollow body is an offshore pipe which contains or consists of layers in precisely the composition and arrangement according to FIG. 2.

In a particularly preferred embodiment the multilayered hollow body is an onshore pipe which contains or consists of layers in precisely the composition and arrangement according to FIG. 3.

In a preferred embodiment the multilayered hollow body, in particular the offshore pipe and/or onshore pipe, contains a steel portion of at most 20% by weight, at most 10% by weight or at most 5% by weight, in each case based on the total weight of the hollow body; preferably the multilayered hollow body, in particular the offshore pipe and/or onshore pipe, contains no steel.

In a preferred embodiment layer I and/or layer II and/or layer III and/or layer IV and/or layer V and/or layer VI and/or layer VII contains the respective moulding material. The terms “layer” and “moulding material” may then be used synonymously.

The polyamide moulding materials used according to the invention contain not only the described polymer components but optionally further additions. Taking into account the definitions recited further below these further additions include for example:
a) stabilizers,
b) additional polymers,
c) impact modifiers,
d) plasticizers,
e) pigments and/or dyes,
f) additions which increase electrical conductivity, and
g) processing auxiliaries.

It is especially preferable to employ stabilizers in an amount of up to 2% by weight, preferably up to 1.5% by weight and particularly preferably up to 1.2% by weight and/or pigments in an amount of up to 1.5% by weight, preferably up to 1.2% by weight and particularly preferably of 0.1% to 1% by weight and/or impact modifiers in an amount of up to 10% by weight, preferably up to 9% by weight and particularly preferably up to 8% by weight.

In a preferred embodiment the moulding materials contain an efficacious amount of an oxidation stabilizer and particularly preferably an efficacious amount of an oxidation stabilizer in conjunction with the efficacious amount of a copper-containing stabilizer. Examples of suitable oxidation stabilizers include aromatic amines, sterically hindered phenols, phosphites, phosphonites, thiosynergists, hydroxylamines, benzofuranone derivatives, acryloyl-modified phenols etc. Such oxidation stabilizers are commercially available in a multitude of types, for example under the trade names Naugard 445, Irganox 1010, Irganox 1098, Irgafos 168, P-EPQ or Lowinox DSTDP. The moulding materials generally contain about 0.01% to about 2% by weight and preferably about 0.1% to about 1.5% by weight of an oxidation stabilizer.

The moulding materials may moreover also contain a UV stabilizer/a light stabilizer of the HALS type. Suitable UV stabilizers are primarily organic UV absorbers, for example benzophenone derivatives, benzotriazole derivatives, oxalanilides or phenyltriazines. Light stabilizers of the HALS type are tetramethylpiperidine derivatives; these are inhibitors that act as radical scavengers. UV stabilizers and light stabilizers may advantageously be used in combination. Both are commercially available in a multitude of types; the manufacturer's instructions may be followed in respect of the dosage.

The moulding materials may additionally contain a hydrolysis stabilizer, for instance a monomeric, oligomeric or polymeric carbodiimide or a bisoxazoline.

Examples of other polymers that may be present in the moulding materials as additions include polyetheramides or polytetrafluoroethylene (PTFE).

Impact-modifying rubbers for polyamide moulding materials are prior art. They contain functional groups which originate from unsaturated functional compounds that were either incorporated into the main chain by polymerization or grafted onto the main chain. The most commonly used are EPM or EPDM rubber that has undergone free-radical grafting with maleic anhydride. Rubbers of this kind can also be used together with an unfunctionalized polyolefin, for example isotactic polypropylene, as described in EP-A-0 683 210.

Plasticizers and the use thereof in polyamides are known to those skilled in the art. A general overview of plasticizers suitable for polyamides may be found in Gächter/Müller, Kunststoffadditive, C. Hanser Verlag, 2nd edition, page 296.

Examples of customary compounds suitable for use as plasticizers include esters of p-hydroxybenzoic acid having 2 to 20 carbon atoms in the alcohol component or amides of arylsulfonic acids having 2 to 12 carbon atoms in the amine component, preferably amides of benzenesulfonic acid.

Suitable plasticizers include inter alia ethyl p-hydroxybenzoate, octyl p-hydroxybenzoate, i-hexadecyl p-hydroxybenzoate, n-octyltoluenesulfonamide, n-butylbenzenesulfonamide or 2-ethylhexylbenzenesulfonamide.

Examples of suitable pigments and/or dyes include carbon black, iron oxide, zinc sulfide, ultramarine, nigrosin, pearlescent pigments and metal flakes.

Examples of additions which increase electrical conductivity include conductive carbon black or carbon nanotubes.

Examples of suitable processing aids include paraffins, fatty alcohols, fatty acid amides, stearates such as calcium stearate, paraffin waxes, montanates or polysiloxanes.

The respective moulding material is produced from the individual constituents in a manner known to those skilled in the art by melt mixing.

The EVOH of the barrier layer (layer III) is a copolymer of ethylene and vinyl alcohol. The ethylene content in the copolymer is generally 24 to 44 mol %, preferably 27 to 38 mol % and particularly preferably 30 to 35 mol %. A multitude of types are commercially available. In accordance with the prior art the moulding material may contain further additions such as are customary for barrier layer applications in addition to the EVOH. Such additions are generally know-how of the EVOH supplier.

In a preferred embodiment exclusively the barrier layer (layer III) contains EVOH.

In a preferred embodiment exclusively the barrier layer (layer III) contains EVOH and consists thereof (100% by weight EVOH).

EVOH barrier layers are known to those skilled in the art from the publication EP 1 216 826 B1.

When the multilayered hollow body according to the invention is used for conducting or storing flammable liquids, gases or dusts, for example fuel or fuel vapours, it is advisable to render at least one of the layers belonging to the composite electrically conductive. This can be achieved by compounding with an electrically conductive addition by any prior art method. Examples of conductive additions that may be used include conductive carbon black, metal flakes, metal powder, metallized glass beads, metallized glass fibres, metal fibres (for example of stainless steel), metallized whiskers, carbon fibres (including metallized carbon fibres), intrinsically conductive polymers or graphite fibrils. It is also possible to use mixtures of different conductive additions.

In the preferred case the electrically conductive layer is in direct contact with the medium to be conducted or stored and has a specific surface resistivity of not more than 10⁹ Ω/square and preferably not more than 10⁶ Ω/square. The method of measurement for determining the resistance of multilayer pipes is elucidated in SAE J 2260 of November 2004. In this case either the corresponding layer as a whole has been rendered electrically conductive or is composed of two sublayers, of which one has been rendered electrically conductive and the other rendered electrically nonconductive. The electrically conductive innermost layer is more preferably layer 1.

When the multilayered hollow body according to the invention is implemented as a hollow profile (for example a pipe) or container, said body may further be sheathed with an additional elastomer layer. Both crosslinking rubber compositions and thermoplastic elastomers are suitable for the sheathing. The sheathing may be applied to the multilayered hollow body/parts with and without the use of an additional adhesion promoter, for example by coextrusion, extrusion through a crosshead die or by sliding a prefabricated elastomer hose over the ready-extruded multilayer pipe. The sheathing generally has a thickness of 0.1 to 4 mm and preferably of 0.2 to 3 mm.

Examples of suitable elastomers include chloroprene rubber, ethylene-propylene rubber (EPM), ethylene-propylene-diene rubber (EPDM), epichlorohydrin rubber (ECO), chlorinated polyethylene, acrylate rubber, chlorosulfonated polyethylene, silicone rubber, plasticized PVC, polyetheresteramides or polyetheramides.

The manufacturing of the multilayered hollow body may be carried out in single- or multi-stage fashion, for example by single-stage processes by means of sandwich moulding, coextrusion, coextrusion blow moulding (for example including 3D blow moulding, extrusion of a parison into an open half-mould, 3D parison manipulation, suction blow moulding, 3D suction blow moulding, sequential blow moulding) or by multistage processes as described in U.S. Pat. No. 5,554,425 for example. Provided the multilayered hollow body according to the invention comprises a layer VI which comprises a moulding material containing carbon fibre-reinforced PA 12, in particular in the form of unidirectionally endless fibre-reinforced tapes, extrusion is initially followed by a winding and a downstream extrusion.

In a second aspect the invention relates to the use of the multilayered hollow body according to the invention
as a hollow profile, preferably as a pipe or as a container; and/or
as a component of a fuel-conducting system; and/or
as a gas conducting pipe; and/or
as an onshore and/or offshore pipe or at least as a subsection thereof.

The multilayered hollow body according to the invention is preferably not used as a brake line, as a clutch line, as a coolant line, as a cable duct, as a forecourt supply pipe, as a ventilation duct and/or as an air intake pipe.

The multilayered hollow body according to the invention is preferably not used in a car.

In a third aspect the invention relates to a fuel-conducting apparatus comprising the multilayered hollow body according to the invention.

The fuel-conducting apparatus is preferably a fuel line, a fuel container, a hydraulic line, a brake line, a clutch line, a coolant line, a liner for rigid or flexible pipes in the oil or gas extraction industry or a line for an umbilical.

In a fourth aspect the invention relates to a fuel-conducting installation comprising the multilayered hollow body according to the invention and/or the apparatus according to the invention.

The fuel-conducting installation is preferably
an onshore pipeline, an offshore pipeline or a combination thereof.

A further example of an installation according to the invention is a floating wind farm which preferably produces H₂ directly on a platform and exports it to land.

The fuel is preferably hydrogen (H₂), H₂S, CO₂, CH₄ or a mixture thereof, particularly preferably hydrogen (H₂).

All definitions of the multilayered hollow body according to the first aspect of the invention also apply in connection with the second, the third and the fourth aspect of the invention.

The invention shall be elucidated by way of example in the experimental part which follows.

FIG. 1 elucidates that the H₂ permeation in the PA 12-EVOH-MLT system according to the invention is drastically reduced compared to identical-thickness monopipes made of different polymers/polymer systems. Gas permeability G is plotted along the y-axis.

H₂ permeation was determined as follows: The pipes were sealed at one end with a blank flange which has measurement connections for permanent pressure and temperature monitoring. After sealing the test pipes, they were filled with the test gas and stored for 4-6 weeks for conditioning. In the conditioning the pipe is contacted with the test gas until the plastic is completely saturated with the test gas and a constant permeation rate has been established. After completion of the conditioning phase the pipes were clamped into special permeation measurement cells and prepared for examination. The measurement cells are gastight balance spaces made of stainless steel which encompass the pipe over a test length of about 30 cm. The measurement cells themselves are in turn provided with two measurement connections for pressure and temperature control and a connection for sampling. At commencement of measurement the measurement cells were purged with nitrogen and adjusted to a positive pressure of about 100 mbar. The permeate which penetrates the pipe wall in the region of the test length is captured in the measurement cell. During the examination period the hydrogen permeate accumulates in the measurement cell. At regular intervals gas samples were taken from the measurement cells and analysed by gas chromatography in the test laboratory. The gas composition (N₂, H₂) provides information about the amount of hydrogen that has penetrated the pipe wall per unit time. The concentration increase of hydrogen in the measurement cell resembles a linear function and reflects the permeation rate. The permeation rate is sufficiently precisely determined using at least 4 measurement points (pressure and temperature constant). By taking into account the inner mantle area (permeation area) and the partial pressures (absolute) the permeation rate is used to calculate the gas permeability G and, using the wall thickness of the pipes, the permeation coefficient (PC). In tests at room temperature (about 20° C.) the permeation coefficients of hydrogen were determined at different internal pressures, wherein the plastic pipes are only mounted in the seals at the ends of the permeation cell (no supporting of the pipe mantle surfaces).

The incorporation of an EVOH barrier layer makes it possible to reduce the permeation coefficient (PC) by up to three orders of magnitude in the temperature range relevant for H₂ applications (30° C.-50° C.).

FIG. 2 shows an offshore pipe. This is composed of the following layers from the inside outwards:
Layer I: optionally high purity (HP) inner layer,
Layer II: optionally additional adhesion promoter (specific for HP inner layer),
Layer III: H₂ barrier (EVOH) as inner layer,
Layer IV: adhesion promoter,
Layer V: chain-extended structural pipe,
Layer VI: pressure-bearing endless reinforcement and
Layer VII: protective pipe.

Layers III to V form the MLP as a liner (MLP=multilayer pipe system).

Layers I to V form the HP MLP as a liner (HP=high purity; MLP=multilayer pipe system).

FIG. 3 shows an onshore pipe. This is composed of the following layers from the inside outwards:
Layer I: optionally high purity (HP) inner layer,
Layer II: optionally additional adhesion promoter (specific for HP inner layer),
Layer III: H₂ barrier (EVOH) as inner layer,
Layer IV: adhesion promoter and
Layer V: chain-extended structural pipe.

Layers III to V form the MLP as a pressure pipe (MLP=multilayer pipe system).

Layers I to V form the HP MLP as a pressure pipe (HP=high purity; MLP=multilayer pipe system).

FIGS. 4 and 5 relate to hot-plate welding of onshore pipes according to FIG. 3.

FIG. 4 shows that in the case of an intact welded test specimen no EVOH contamination of the weld seam was optically apparent, i.e. the welding does not cause mechanical weakening of the weld seam.

FIG. 5 shows the relative change in the properties “yield stress”, “elongation” and “modulus” of welded monopipes (white) and MLTs (grey), i.e. multilayered pipe systems according to the invention, relative to unwelded PA 12 monopipes (0% reference). According to the invention, no EVOH contamination of the weld seam occurs. There is thus no appreciable effect on the structural integrity of the weld seam; the effect is merely in the range of customary standard deviation.

According to FIG. 6 FEM simulations were used to calculate the minimum bending radius (MBR) at 23° C. and an innermost EVOH barrier layer.

| | | | |
|---|---|---|---|
| Dimension | PA12 | EVOH | MBR |
| of pipe | (outer layer) | (innermost layer) | (simulation) |

| | | | | | |
|---|---|---|---|---|---|
| OD110 | 6.3 | mm | 0.3 mm | 1.85 | m |
| SDR17 | 6.6 | mm | — | 1.3 | m |
| OD110 | 7.2 | mm | 0.4 mm | 0.92 | m |
| SDR13 | 7.6 | mm | — | 0.9 | m |
| OD160 | 14.3 | mm | 0.3 mm | 1.45 | m |
| SDR11 | 14.6 | mm | — | 1.3 | m |

It should be mentioned that the failure criterion for the MBR is a buckling of the pipe. A higher SDR value/lower wall thickness therefore leads to earlier buckling. The high stiffness of EVOH (3800 MPa) in conjunction with relatively low flow stress (35 MPa) results in a higher risk of bulging compared to PA 12 (1320 & 40 MPa). An 110 SDR17 pipe would have an MBR of 1.85 m-markedly greater than a single-layered pipe of identical dimensions which would have an MBR of 1.3 m.

1. A multilayered hollow body for transport, transmission, distribution and/or storage of gases and/or liquids, the multilayered body, from the inside outwards, comprising:
optionally a layer I which comprises a moulding material containing polyethylene (PE), polyvinylidene fluoride (PVDF), polytetrafluoroethylene (PTFE), perfluoroalkoxy (PFA), poly(tetrafluoroethylene-perfluoromethylvinyl ether) (MFA), fluoroethylenepropylene (FEP) and/or ethylene-chlorotrifluoroethylene (ECTFE);
optionally a layer II which is an adhesion promoter layer and comprises or consists of a moulding material containing PA 6, PA 6.12, copolymers thereof and/or mixtures thereof;
a barrier layer (layer III) which comprises or consists of a moulding material containing ethylene-vinyl alcohol copolymer (EVOH);
an adhesion promoter layer (layer IV) which comprises or consists of a moulding material containing PA 6, PA 6.12, copolymers thereof and/or mixtures thereof;
a layer V which comprises a moulding material containing at least one chain-extended polyamide;
wherein the at least one chain-extended polyamide is obtainable using a chain-extending additive which has at least 2 carbonate units per molecule;
optionally a layer VI which comprises or consists of a moulding material containing carbon fibre-reinforced PA 12; and
optionally a layer VII which is a protective sheathing.

2. The multilayered hollow body according to claim 1, wherein
the moulding material of layer V is obtainable by condensation of a PA 12, PA 6.12 and/or bio-PA moulding material with a compound having at least two carbonate units and the polyamide proportion of the PA 12, PA 6.12 and/or bio-PA moulding material contains at least 5 ppm of phosphorus in the form of an acidic compound as a consequence of manufacture, wherein
a) 0.001% to 10% by weight, based on the at least one chain-extended polyamide, of a salt of a weak acid is added to the at least one chain-extended polyamide before compounding or during compounding and
b) a mixture of the finished compound and 0.005% to 10% by weight, based on the at least one chain-extended polyamide, of the compound having at least two carbonate units is produced.

3. The multilayered hollow body according to claim 2, wherein
the polyamide proportion contains 20 to 500 ppm of phosphorus in the form of an acidic compound; and/or
the at least one chain-extended polyamide is admixed with 0.001% to 5% by weight, of a salt of a weak acid; and/or
the at least one chain-extended polyamide was produced using a diamine or polyamine as a chain-transfer agent; and/or
the compound having at least two carbonate units is employed as a masterbatch.

4. The multilayered hollow body according to claim 1, wherein said body
does not contain layer I; or
does not contain layer I and layer II, and layer III is a barrier and inner layer.

5. The multilayered hollow body according to claim 1, wherein
layers I, II, III, IV and V or
layers I, II, III, IV, V, VI and VII or
layers III, IV and V or
layers III, IV, V, VI and VII
are directly consecutive; and/or
layer III is arranged off-centre;
and/or
a thickness of layer III is at least 0.2 mm and at most 0.6 mm, a thickness of layer IV is at least 0.1 mm and at most 0.2 mm and a thickness of layer V is at least 6.0 mm and at most 10.0 mm;
and/or
an internal diameter of the multilayered hollow body is at least 30 mm or at least 50 mm and/or at most 160 mm or at most 300 mm or at most 350 mm.

6. The multilayered hollow body according to claim 1, wherein the moulding material of layer V
contains additional polyamides, copolymers thereof and/or mixtures thereof.

7. The multilayered hollow body according to claim 1, wherein
the moulding material of layer I contains PE-HP, PVDF-HP, PFA-HP, MFA-HP and/or FEP-HP, in each case individually or altogether in an amount of at least 50% by weight, in each case based on the total weight of layer I and/or the moulding material of layer I; and/or
in the moulding material of layer III the EVOH has an ethylene content of at least 10% by weight; and/or
the moulding material of layer V contains chain-extended PA 12, chain-extended PA 6.12, chain-extended bio-PA, copolymers thereof and/or mixtures thereof, in each case individually or altogether in an amount of at least 80% by weight, in each case based on the total weight of layer V and/or the moulding material of layer V.

8. The multilayered hollow body according to claim 1, wherein said body is produced by a single- or multi-stage extrusion process or coextrusion process, optionally in conjunction with a winding.

9. The multilayered hollow body according to claim 1, wherein said body is windable.

10. The multilayered hollow body according to claim 1, wherein
(i) said body contains or does not contain layer I and layer II and layer III is a barrier and inner layer,
layer IV is a moulding material which comprises or contains PA 6 and PA 6.12,
layer V is a moulding material which comprises or contains chain-extended PA 12,
no additional outer layers follow in the outward direction, and
layers I, II, if present, III, IV and V are directly consecutive;
or
(ii) said body contains or does not contain layer I and layer II and layer III is a barrier and inner layer,
layer IV is a moulding material which comprises or contains PA 6 and PA 6.12,
layer V is a moulding material which comprises or contains chain-extended PA 12,
there adjoins in the outward direction a further outer layer (layer VI) which is a moulding material comprising or containing carbon fibre-reinforced PA 12,
there adjoins in the outward direction yet a further outer layer (layer VII) which is a protective sheathing, and
layers I, II, if present, III, IV, V, VI and VII are directly consecutive.

11. The multilayered hollow body according to claim 1, wherein said body is
a hollow profile; and/or
a component of a fuel-conducting system; and/or
a gas conducting pipe; and/or
an onshore and/or offshore pipe or at least a subsection thereof.

12. The multilayered hollow body according to claim 1, wherein
the moulding material of layer I and/or the moulding material of layer II and/or the moulding material of layer III and/or the moulding material of layer IV and/or the moulding material of layer V and/or the moulding material of layer VI and/or the moulding material of layer VII contains one or more additives; and/or
said body contains one or more additional layers selected from the group consisting of an electrically conductive layer and an elastomer sheathing.

13. The multilayered hollow body according to claim 1, wherein the moulding material of layer I and/or the moulding material of layer II and/or the moulding material of layer III and/or the moulding material of layer IV and/or the moulding material of layer V and/or the moulding material of layer VI and/or the moulding material of layer VII each independently of one another contain no plasticizer.

14. A method, comprising:
using the multilayered hollow body according to claim 1
as a hollow profile; and/or
as a component of a fuel-conducting system; and/or
as a gas conducting pipe; and/or
as an onshore and/or offshore pipe or at least as a subsection thereof.

15. A fuel-conducting installation, comprising:
the multilayered hollow body according to claim 1.
